(19) United States
(12) Patent Application Publication
(10) Pub. No.: US 2005/0033534 A1
(43) Pub. Date: Feb. 10, 2005

(54) Automated utility metering system

(75) Inventors: Ernest Villicana, Tempe, AZ (US); Satish Kholay, Phoenix, AZ (US); Vijay Pande, Bangalore (IN)

Correspondence Address: DONALD J. LENKSZUS, PO BOX 3064, CAREFREE, AZ, 85377-3064, US

(73) Assignee: POWERONEDATA CORPORATION, Phoenix, AZ (US)

(21) Appl. No.: 10/637,753

(22) Filed: Aug. 8, 2003

(51) Int. Cl. G06F 19/00

(52) U.S. Cl. 702/61

(57) ABSTRACT

An automatic metering system in accordance with the principles of the invention comprises a plurality of groups of geographically related utility meters. Each utility meter comprises an interface unit operable to accumulate usage data and to transmit the usage data over power lines utilizing power line carrier. The system further comprises a plurality of data forwarding apparatus each comprising power line carrier communication apparatus operable to receive usage data from each utility meter in its group of utility meters. Each data forwarding apparatus comprises a first wireless communication module. Each data forwarding apparatus has a geographic relationship to its corresponding group of utility meters. A computer is located geographically apart from the plurality of data forwarding apparatus. The central computer comprises a second wireless communication module and operates cooperatively with each data forwarding apparatus to upload usage data from all of the utility meters via the plurality of data forwarding apparatus.

### FIELD OF THE INVENTION

This invention pertains to automated utility company meters reading systems, in general, and to watt-hour metering systems and methods for the measurement of electrical energy consumption for revenue metering applications, in particular.

### BACKGROUND OF THE INVENTION

Typically, electrical power supplied for residential and small business applications is single-phase alternating current power. To measure the consumption of electricity in residential applications, a utility company meter is provided at the electrical service entrance to the residence.

Utility company meters are of three general types, namely, electromechanical based meters, purely electronic component based meters, and hybrid electromechanical/electronic meters. The electromechanical and hybrid type meters are essentially an induction motor in which the moving element is a rotating disk. The speed of rotation of the disk is directly proportional to the voltage applied and the amount of current flowing through the motor. The phase displacement of the current, as well as the magnitude of the current, is automatically taken into account by the meter, i.e., the power factor influences the speed of rotation of the disk. The result is that the disk rotates with a speed proportional to true power. In the electromechanical type of meters, a register is used to register the number of revolutions, and the gearing is arranged to be read directly in kilowatt-hours.

The electric utility meters most commonly in use are of the electromechanical type. The meters are generally highly reliable, but do not lend themselves to remote or automated reading.

Hybrid meters typically utilize electronic circuitry in combination with the rotating disk to permit at least limited two-way communication to/from the meter. Typically, the two-way communication is limited to reading the meter via a proprietary communications link that frequently is a limited range radio frequency link.

It is not uncommon for electric utilities to utilize both simple and complex tariffs. The tariffs may be time of use type tariffs, or may be changed from time to time or on predetermined dates to provide for various time of use type of rates.

It is common practice for utility companies to access meter information on only a monthly or 30 day period. In many systems, a meter reader actually views the meter and manually records the meter reading.

### SUMMARY OF THE INVENTION

In accordance with the principles of the invention a low cost automatic meter reading system is provided. The system of the invention utilizes a data pooling or concentration approach to lower capital equipment costs on a per customer basis. The system architecture is layered such that the cost of more complex and expensive apparatus is distributed over the customer base.

The present invention provides the next generation of time-sensitive advanced metering data collection and management solutions for utilities and energy service providers. The meter and system of the invention provide unmatched two-way, secure, access to meter reading over wide geographic areas.

The system measures residential energy consumption and automatically communicates this information to a host computer. The host computer can then be accessed by the end utility customer or other authorized entities. This Internet or web based system offers two-way communication capability to support meter reconfiguration.

An automatic metering system in accordance with the principles of the invention comprises a plurality of groups of utility meters. Each group of utility meters comprises a group of geographically related utility meters. Each utility meter comprises an interface unit operable to accumulate usage data and to transmit the usage data over power lines utilizing power line carrier. The system further comprises a plurality of data forwarding apparatus each comprising power line carrier communication apparatus operable to receive usage data from each utility meter in its group of utility meters. Each data forwarding apparatus comprises a first wireless communication module. Each data forwarding apparatus has a geographic relationship to its corresponding group of utility meters. A computer is located geographically apart from the plurality of data forwarding apparatus. The central computer comprises a second wireless communication module and operates cooperatively with each data forwarding apparatus to upload usage data from all of the utility meters via the plurality of data forwarding apparatus.

In accordance with one aspect of the invention, at least one data forwarding apparatus comprises apparatus operable to communicate usage data from another one of the data forwarding apparatus to the computer. Each data forwarding apparatus is operable in accordance with a routing algorithm to determine a communication path to said computer. The communication path to said computer may be a direct communication path to the computer or an indirect communication path to said computer. The direct communication path comprises a first spread spectrum radio frequency communication link. The indirect communication path comprises a second spread spectrum radio frequency communication link between a first one of the data forwarding apparatus and a second one of the data forwarding apparatus.

In accordance with another aspect of the invention the computer forwards the usage data from the utility meters to a database for storage.

In accordance with another aspect of the invention each meter interface unit comprises a module installed in an existing utility meter. Each module comprises a meter portion that gathers meter data and a modem portion. Each meter portion comprises a pulse acquisition circuit coupled to the meter to receive pulses having a relationship to electricity usage; a micro-controller for receiving, and processing said pulses to generate usage data, and operable to cause said usage data to be transmitted via the modem portion to a corresponding data forwarding apparatus. The meter portion comprises a memory for storing a unique meter number. The memory also stores an initial meter reading and meter constants.

In accordance with another aspect of the invention, the central computer is automatically operable to selectively initiate uploads of data from each of meter interface units via the data forwarding apparatus.

In accordance with another aspect of the invention each utility meter of at least one group of utility meters comprises a second interface unit operable to accumulate usage data and to transmit the usage data over a public switched telephone network; and at least one of the data forwarding apparatus is operable to receive usage data via the public switched telephone network and transmit the received usage data to said computer.

In accordance with another aspect of the invention each utility meter of at least a second group of utility meters comprises a third interface unit operable to accumulate usage data and to transmit the usage data over a wireless link. At least one data forwarding apparatus is operable to receive usage data via the wireless link.

A system in accordance with the invention utilizes a scalable architecture that permits power usage data to be collected, calculated and stored incrementally for automatic transmission.

In accordance with the principles of the invention a method of remotely configuring a utility meter, includes the steps of providing the meter with a unique physical meter number and providing the meter a unique electronic serial number. Further in accordance with the invention the method includes: providing a communication link between the meter and a database, the database being physically remote from said utility meter; storing in the database the unique physical number and the unique electronic serial number; storing in the database information relative to the account to which the meter is assigned; storing in the database rate schedule information for the account; and downloading the rate schedule information from the database to the meter. A server or data concentration computer is utilized to control communications and access to and from the database.

### BRIEF DESCRIPTION OF THE DRAWING

The invention will be better understood from a reading of the following detailed description in conjunction with the drawing figures in which like reference numerals are used to designate like elements, and in which:

FIG. 1 is a block diagram of a meter reading and control system in accordance with the principles of the invention;

FIG. 2 is a block diagram of a meter interface unit utilized in the system of FIG. 1 in accordance with the principles of the invention;

FIGS. 3 and 4 are block diagrams of data forwarding units utilized in the system of FIG. 1 in accordance with the principles of the invention; and

FIGS. 5 is a block diagram of a data concentrator utilized in the system of FIG. 1 in accordance with the invention.

### DETAILED DESCRIPTION

Each utility meter is required to record the electricity consumption at a particular premises. With the advanced metering provided by a system in accordance with the principles of the invention, it is possible to support a number of different pricing plans. These plans vary the cost of electricity of the consumer according to the time of day and/or maximum load that the consumer draws from the utility grid. The system described here allows a utility company to remotely control the schedule programming of individual meters from a central computer. All information relating to calendars, daily schedules (On peak, Off peak, shoulder 1 and shoulder 2 rate time intervals) and seasonal information is downloaded annually from the database server or whenever there is a change required (such as a rate change or if a customer changes from a flat rate kWh plan to a Time of Use plan).

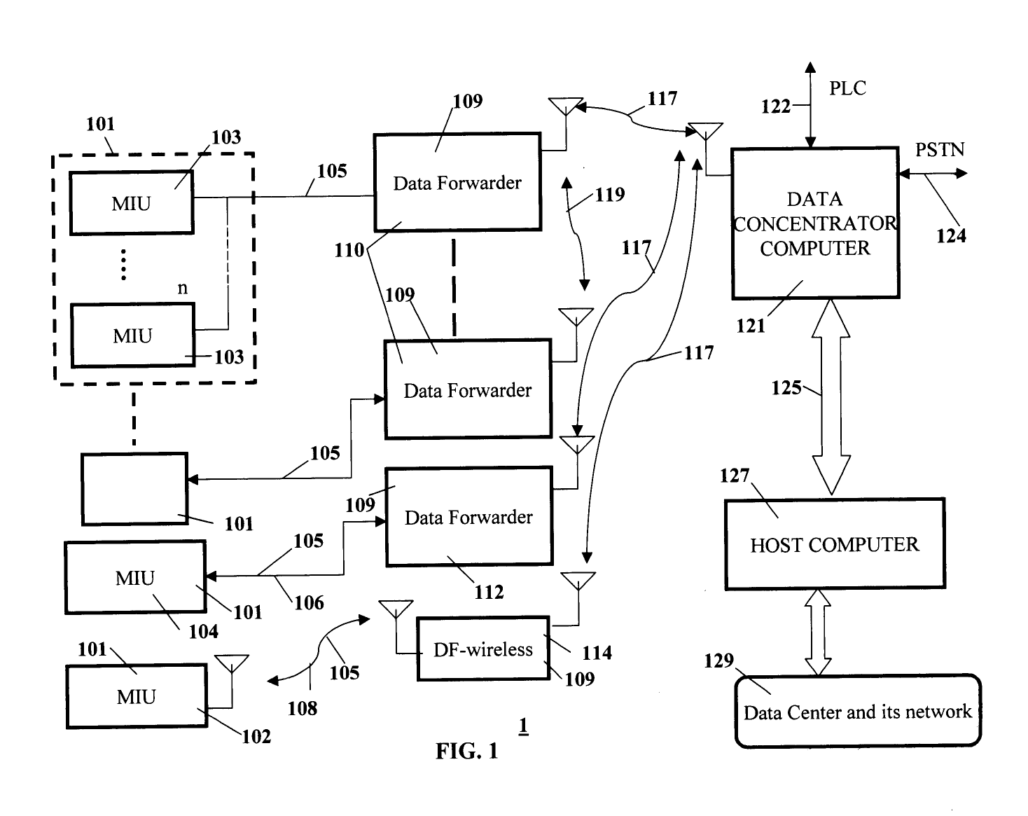

In accordance with the principles of the invention, a new and novel system and method for acquiring metered information is provided. The system in which the meters FIG. 1 shows an automatic meter reading system 1 in accordance with the principles of the invention. The system of the invention provides all the features of an automatic meter reading system but by selective distribution of technologies utilized it has a lower cost per end user account than prior automatic meter reading systems.

A significant feature of the invention as shown in FIG. 1 is that a layered architecture is utilized. System I includes pluralities of groups 101 of meter interface units 102, 103, 104. Each of the meter interface units 102, 103, 104 has a bi-directional communication port coupled to a link 105 for transmission and reception of data between a power meter and a data forwarder 109. Link 105 for meter interface units 103 is a bi-directional power line carrier link. Link 105 for meter interface unit 102 is a bi-directional wireless link 108. Link 105 for each meter interface unit 104 is a bi-directional link 106 over the public switched telephone network (PSTN). Each group of meter interface units 102, 103, 104 is coupled by a corresponding link 105 to a corresponding data forwarder unit 121. Data concentrator computer 121 is coupled to the public switched telephone network via a communication link 124 and also includes direct links power lines for a power line carrier bi-directional link 122.

Data concentrator computer 121 is connected via a communication link 125 to a Host computer 127 co-located at a data center 129.

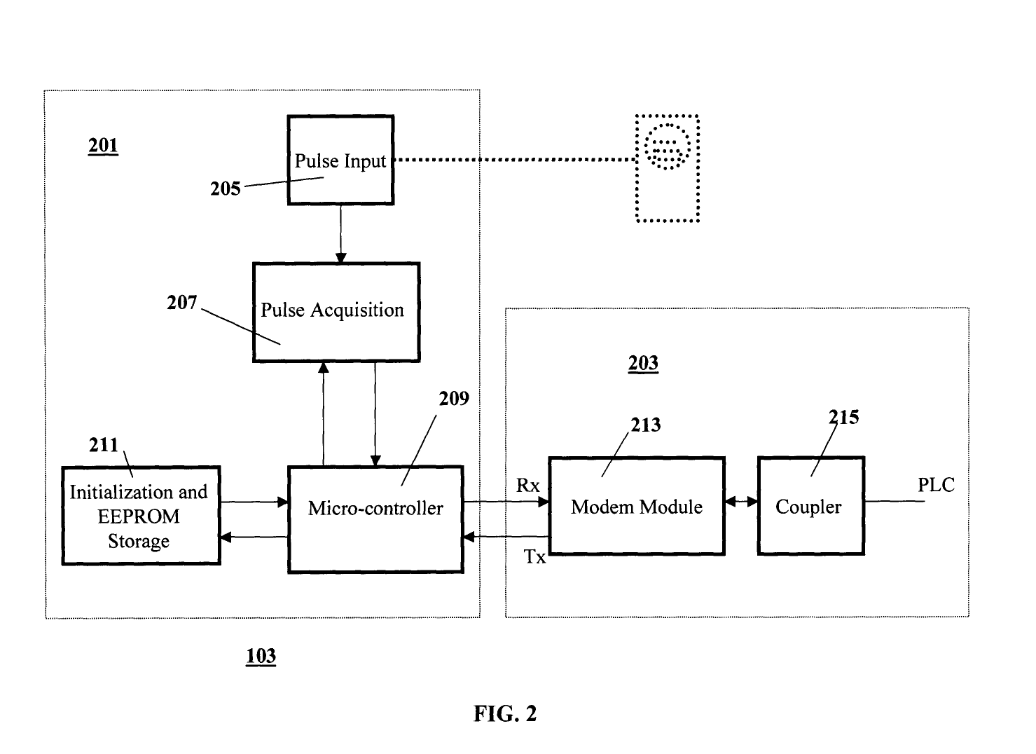

Meter interface unit 102, 103, 104 is shown in FIG. 2 along with a representative meter which is shown in phantom. Meter interface unit 102, 103, 104 is an integrated unit that is adapted to be retrofitted in a power meter that produces pulse output signals. In the illustrative embodiment, each meter interface unit 102, 102, 104 is implemented on a printed circuit board that is mountable in the power meter.

Each meter interface unit comprises a modem portion 203 that is changed according to the nature of the communications link 105 that data is to be communicated over and a meter portion 201 that gathers meter data and exchanges data via modem portion 203.

Meter portion 201 includes a pulse signal interface 205 coupled to the meter and coupleable to a hand held device that is utilized to provide initial meter programming. Pulse acquisition circuit 207 for providing conditioned pulses to a pulse acquisition circuit 207 receives meter pulses or input pulses and provides them to micro-controller 209. Micro controller 209 has EEPROM 211 coupled thereto. A unique silicon ID is fused in this EEPROM 211. Through a hand held device, the unique meter number, initial meter reading and meter constants are programmed into EEPROM 211.

Modem portion 203 comprises a modem module 213 Modem module 213 may be a standard type of modem that is commercially available. In the illustrative embodiment, modem module 213 is selected to have a bit rate of 2400 bps, 19.2 Kbps or 100 Kbps based on the need.

Coupler circuit 215 is used to couple modem module 213 to a power line and provides power line carrier modulation and demodulation for meter interface units 103. Coupler circuit 215 provides an interface to the public switched telephone network in meter interface units 104 and provides an of interface for the wireless meter interface units 102.

Specifications for meter interface units in the illustrative embodiment are set forth in Table 1.

TABLE 1

| Description | Specification | | |
|---|---|---|---|
| Pulse | Voltage | 0-5 V | Rising edge |
| | | | active |
| | Pulse width | 50 ± 20 ms | |
| | Min. duration | 20 ms | |
| | between pulses | | |
| Communication | Power Line | Modulation | DSSS |
| with DCU | Carrier | Operating | 9-110 kHz |
| | | frequency | |
| | | Baud rate | 9600 bps |
| | Power | 1-phase-2-wire | |
| | distribution | | |
| | Communication | Half-duplex, bi- | |
| | | directional | |
| | Error detection | CRC | |
| Communication | RS-232cable | Baud rate: | |
| with | | 4800 bps | |
| Handheld | | | |
| Programming | | | |
| Unit | | | |
| Initialization | TTL level, RXD, TXD, GND3-wire | | Initialization |
| Port | connection | | when power off |
| Serial data | Start bit | 1 bit | |
| | Stop bit | 1 bit | |
| | Data bit | 8 bit | |
| Initialization | Meter Constant | Meter | 6 digit decimal |
| Parameters | Meter Window | Actual value | Max. |
| | Base Value | | Digit YYYYY |
| | Address code | 8 digit | Leading 0 |
| | | decimal | |
| Supply Voltage | AC220 V ± 20% | Line | |
| | 50/60 Hz | Neutral | |
| Operating | +5 V | | |
| voltage | −5 V | | |
| Power | Idle | 0.1 W | |
| Consumption | Active | 0.25 W | At transmission |
| Tariff | 4 | Peak, Semi- | |
| | | peak, Normal, | |
| | | Low | |
| Time-of-use | 12 | | Optional |
| Memory | EEPROM | 4K Bits | |
| Capacity | | | |

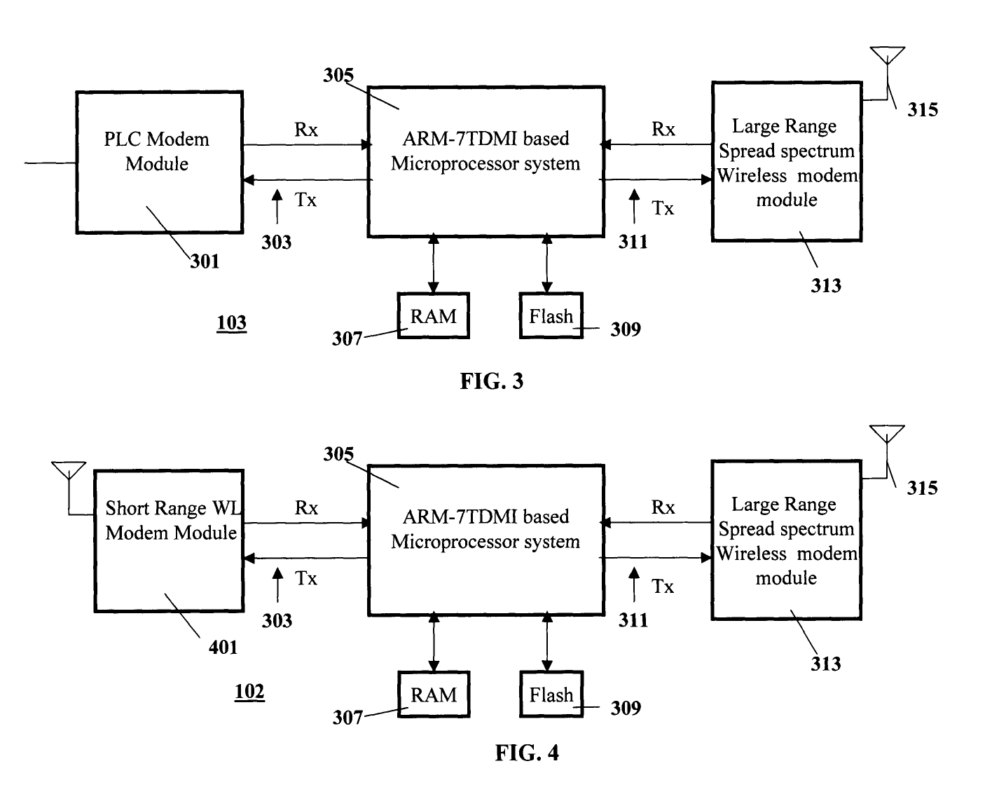

Turning now to FIGS. 3 and 4, data forwarders 102, 103 are illustrated for use with a wireless link 108 and a power line carrier link 105, respectively. The designs of the two data forwarders 102, 103 are substantially the same with the principal difference being the use of a wireless modem module 401 or a power line carrier modem module 301. Each data forwarder 102, 103 is a stand alone unit comprising a microprocessor 305 and associated random access memory 307 and a memory 309 which may be a flash memory or the like. The microprocessor 305 may be any commercially available microprocessor such as an ARM7TDMI with 1 MB of RAM 307, 24K of EEPROM 309 and with two serial ports 303, 311. An identification is stored in flash memory 309. A wireless spread spectrum modem module 313 couples to wireless links 115, 117. Each data forwarder 109 is encased in a weatherproof enclosure.

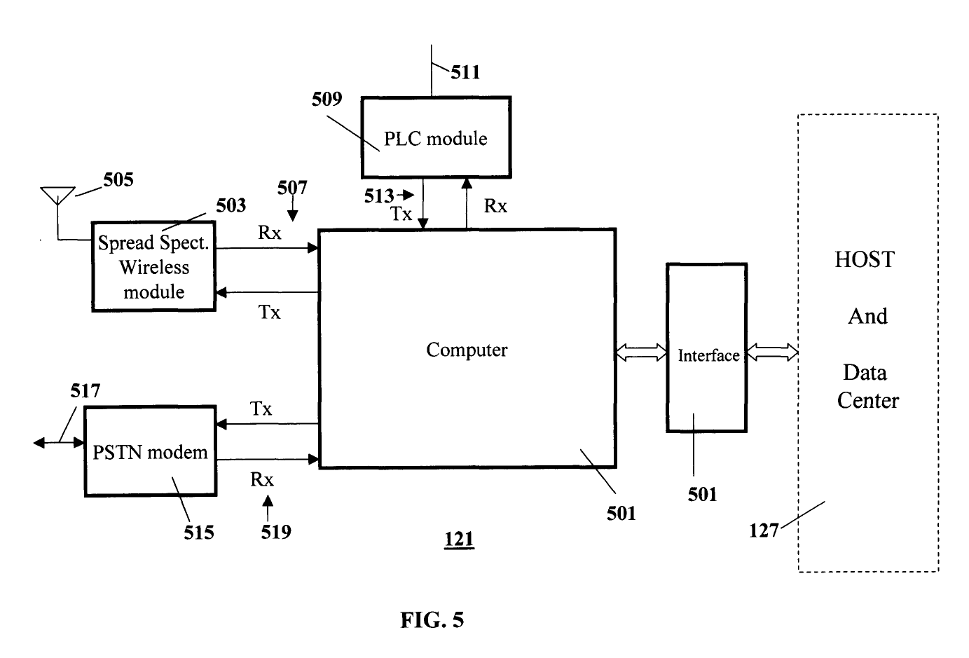

FIG. 5 shows the data concentrator 121. Data concentrator 121 includes a stand-alone computer 501. Associate with computer 501 are networking ports and storage capacity on hard disk drives and other memory typically associated with computers. A spread spectrum modem module 503 is interfaced to computer 501 via one of computer ports 507. A PLC modem module 509 is interfaced to computer 501 via port 513. A PSTN modem is interfaced to computer 501 via port 519.

Data concentrator computer 121 comprises a host computer 127 along with network of computers 129. Computer 121 is a high-end computer, which is connected to data concentrator computer 121 and to a network of computers 129. Computer 121 may be a commercially available computer and in the illustrative embodiment is an Intel Pentium-4 based computer system with large RAM and Hard disk drive capacity of at least 30 GB.

Host computer 127 is connected to the network of computers 127 through Ethernet or a wireless LAN network.

Specifications for the data concentrator computer 121 in the illustrative embodiment are set forth in Table 2.

TABLE 2

| Description | Specification | | |
|---|---|---|---|
| Communication | Ethernet | | 2-10 MBPS |
| with HCU | PSTN | V3.4 or | 4800 bps or |
| | | above | above |
| Local | RS-232 | | |
| communication | | | |
| Serial data | Start bit | 1 bit | |
| | Stop bit | 1 bit | |
| | Data bit | 8 bit | |
| Communication | Power Line | Modulation | DHSS |
| with Meter | Carrier | Operating | 110 kHz |
| MIU, MMIU | | frequency | |
| | | Baud rate | 9600 bps |
| | Power | 1-phase-2-wire | |
| | distribution | | |
| | Communication | Half-duplex, bi- | |
| | | directional | |
| | Error detection | CRC | |
| | Phase detection | Zero-crossing | |
| Communication | Wireless | Modulation | 9600 bps |
| with Meter | | | |
| MIU, MMIU | | | |
| Communication | PSTN | Standard | 2400 bps |
| with Meter | | | |
| MIU, MMIU | | | |
| Data file format | Standard text file | | |
| Data Storage | HDD | 20 GB | |
| Software platform | Windows/DOS/Linux | | |
| Supply Voltage | AC220 V ± 20% | 1 phase | |
| | 50/60 Hz | | |
| Tariff | 4 | Peak, Semi-peak, | |
| | | Normal, Low | |
| Time-of-use | 12 | | |
| Status indicators | DCC has a fixed phone number/ | | |
| Operating | Storage | −40C-+85C | |
| Environment | temp. | | |
| | Operating | −20C-+70C | |
| | temp. | | |
| | Relative | 5%-95% | Non- |
| | Humidity | | condensing |

Each meter interface unit 102, 103, 104 counts pulses coming from its associated meter, converts the pulses into a meter reading and stores the meter reading in memory. Each meter interface unit 102, 103, 104 also implements a protocol for two-way communication to report the meter reading and meter activity to the Data concentration computer 121 via its associated modem module 213. Micro-controller 209 implements protocol for two-way communication to modem 213 and to data concentrator computer 121. Communication between each meter interface unit 102, 103, 104 through its associated data forwarder 109.

Each data forwarder 109 is device receives and forwards data coming from data concentration computer 121 to the meter interface units 102, 103, 104 or data coming from each meter interface unit 102, 103, 104 to data concentration computer 121. Each data forwarder 109 also functions as a router for other data forwarder units 121 connected to different groups 101 of meter interface units which may not be accessible by its associated data concentration computer 121.

In operation the data concentration computer 121 makes a request to a data forwarder 110 first. Data concentration computer 121 then receives meter data via wireless radio frequency spread spectrum links 117, 119. Each time data is received by a data forwarder 109 from data concentration computer 121, the data is analyzed by the data forwarder 109 for routing to other data forwarders via a spread spectrum data link 119 or is to be sent on to a meter interface unit 102, 103, 104 in the group 101 associated with the data forwarder 109 for uploading usage related information from the associated meter. The response of the meter is reported back to data concentration computer 121 via the respective data forwarder 109.

A primary function of data concentration computer 121 is accumulating data from all the various meters coupled to the system via meter interface units 102, 103, 104 and forwarding the accumulated information to data center network 129 through host computer 127. Data concentrator computer 121 temporarily stores the accumulated information obtained from the associated meters and forwards it via host computer 127 to data center network 129 for billing and other related processing.

Host computer 127 is utilized to set up data concentration computer 121 data parameters related to the metering process, and managing data forwarder connectivity related to meters. Setup of all new accounts related to meters, data finders and data center network is carried out from host computer 127. Data acquired from the data concentrator computer 121 is uploaded to data center network 129 by host computer 127. Host computer 127 is an active part of data center 129 but is dedicated to interacting with data concentrator computer 121.

The data center 129 manages the accumulated database of metered data collected from all meter interface units 102, 103, 104 and also provides various services based on the data to utilities, end customer, power companies, and maintenance companies etc.

The invention has been described in terms of embodiments of the invention. It will be apparent to those skilled in the art that various changes and modifications may be made to the embodiments shown and described without departing from either the spirit or scope of the invention. It is intended that the invention include all such changes and modifications. It is further intended that the invention not be limited to the illustrative embodiments shown and/or described. It is intended that the invention be limited only by the scope of the claims appended hereto.

1. An automatic metering system, comprising:
a plurality of groups of utility meters, each of said groups of utility meters comprising a group of geographically related utility meters, each of said utility meters comprising an interface unit operable to accumulate usage data and to transmit said usage data over power lines utilizing power line carrier communication;
a plurality of data forwarding apparatus, each of said data forwarding apparatus comprising power line carrier communication apparatus operable to receive usage data from each utility meter in one corresponding group of said groups of utility meters; each of said data forwarding apparatus comprising a first wireless communication module; each of said data forwarding apparatus having a geographic relationship to its corresponding group of said utility meters; and
a computer located geographically apart from said plurality of data forwarding apparatus, said central computer comprising a second wireless communication module, said central computer operating cooperatively with each data forwarding apparatus of said plurality of data forwarding apparatus to automatically upload usage data from all of said utility meters via said plurality of data forwarding apparatus.

2. An automatic meter reading system in accordance with claim 1, wherein:
at least one of said data forwarding apparatus comprises apparatus operable to communicate usage data from another one of said data forwarding apparatus to said computer.

3. An automatic metering system in accordance with claim 1, comprising:
each of said data forwarding apparatus being operable in accordance with a routing algorithm to determine a communication path to said computer.

4. An automatic metering system in accordance with claim 3, wherein:
said communication path to said computer comprises one of a direct communication path to said computer or an indirect communication path to said computer.

5. An automatic metering system in accordance with claim 4, wherein:
said direct communication path comprise a first spread spectrum radio frequency communication link.

6. An automatic metering system in accordance with claim 5, wherein:
said indirect communication path comprises a second spread spectrum radio frequency communication link between a first one of said data forwarding apparatus and a second one of said data forwarding apparatus and said first one of said data forwarding apparatus.

7. An automatic metering system in accordance with claim 1, comprising:
a database, said computer forwarding said usage data to said database for storage therein.

8. An automatic metering system in accordance with claim 1, wherein;
each of said meter interface units comprises a module installed in an existing utility meter.

9. An automatic metering system in accordance with claim 8, wherein:
each said module comprises a meter portion that gathers meter data and a modem portion.

10. An automatic metering system in accordance with claim 9, wherein;
each said meter portion comprises a pulse acquisition circuit coupled to said meter to receive pulses having a relationship to electricity usage; a micro-controller for receiving, and processing said pulses to generate usage data, and operable to cause said usage data to be transmitted via said modem module to a corresponding data forwarding apparatus.

11. An automatic metering system in accordance with claim 10, wherein:
said meter portion comprises a memory for storing a unique meter number.

12. An automatic metering system in accordance with claim 11, wherein:
said memory stores an initial meter reading and meter constants.

13. An automatic metering system in accordance with claim 1, wherein:
each said utility meter interface unit operable is operable to receive data from said power lines utilizing power line carrier communication;
said central computer second wireless communication module is operable to selectively download data to each of said utility meters via said data forwarding apparatus; and
each said data forwarding apparatus first wireless communication module is operable to receive download data for a corresponding utility meter and to forward said download data to said corresponding utility meter via said poser line communication apparatus.

14. An automatic metering system in accordance with claim 1, wherein:
said central computer is operable to selectively initiate uploads of data from each of said meter interface units via said data forwarding apparatus.

15. An automatic metering system in accordance with claim 1, comprising:
each utility meter of at least one group of said utility meters comprising a second interface unit operable to accumulate usage data and to transmit said usage data over a public switched telephone network; and
at least one of said data forwarding apparatus operable to receive usage data from each utility meter in said at least one group of utility meters via said public switched telephone network and transmit said received usage data to said computer.

16. An automatic metering system in accordance with claim 1, comprising:
each utility meter of said at least a second group of said utility meters comprising a third interface unit operable to accumulate usage data and to transmit said usage data over a wireless link; and
at least one of said data forwarding apparatus operable to receive usage data from each utility meter in said at least a second group of utility meters via said wireless link.

17. An automatic metering system, comprising:
a plurality of groups of utility meters, each of said groups of utility meters comprising a group of geographically related utility meters, each of said utility meters comprising an interface unit operable to accumulate usage data and to transmit said usage data in response to received upload requests, said uploads requests and said usage data being communicated over a communication link selected from the group comprising a power line carrier link, a public switched telephone network communications link; and a wireless link;
a plurality of data forwarding apparatus, each of said data forwarding apparatus comprising apparatus operable to forward said upload requests over a corresponding selected communication link to corresponding ones of said utility meters in a corresponding group of said groups of utility meters and to receive; each of said data forwarding apparatus comprising a first wireless communication module; each of said data forwarding apparatus having a geographic relationship to its corresponding group of said utility meters; and
a computer located geographically apart from said plurality of data forwarding apparatus, said central computer comprising a second wireless communication module, for selectively communicating with said plurality of data forwarding apparatus, said central computer operating cooperatively with each data forwarding apparatus of said plurality of data forwarding apparatus to selectively provide upload requests to said utility meters via said data forwarding apparatus and to receive usage data in response to such requests.

18. An automatic metering system in accordance with claim 17, wherein:
each of said data forwarding apparatus is operable to determine whether a received upload request is to be forwarded to another one of said data forwarding apparatus.

19. An automatic metering system in accordance with claim 18, wherein:
each of said data forwarding apparatus is operable to forward an upload request for another data forwarding apparatus to said another data forwarding apparatus, and to receive upload usage data from said another data forwarding apparatus to said central computer.
